(19) United States
(12) Patent Application Publication
(10) Pub. No.: US 2026/0312210 A1
(43) Pub. Date: Oct. 8, 2026

(54) Chute-Supplied Battery Charging Apparatus for Charging Batteries of Different Sizes

(71) Applicant: Powerchute Ltd., Westbury-in-Severn (GB)

(72) Inventor: Thomas Marshall-Andrews, Westbury-on-Severn (GB)

(21) Appl. No.: 19/483,311

(22) PCT Filed: May 8, 2024
(86) PCT No.: PCT/GB2024/051197

§ 371 Date: Nov. 11, 2025

(30) Foreign Application Priority Data
May 12, 2023 (GB) 2307050.1
May 12, 2023 (GB) 2307051.9

(51) Int. Cl. H01M 50/267; B07C 5/06; G01B 3/42; H01M 50/213

(52) U.S. Cl. CPC H01M 50/267; B07C 5/065; G01B 3/42; H01M 50/213

(57) ABSTRACT

A battery charger device (10) having a chute (12) to supply batteries (1) to a charge location via a conveyor (20). In one aspect, the conveyor (2) includes battery cradle (22) with two seats (24, 28) between which a battery (1) can be moved by operation of the conveyor (2). In another aspect, the conveyor (2) includes a cradle cover to block the passage from the chute to the seats. In one aspect, the charge location is shaped with different width clearances, to accommodate different battery diameters. The aspects individually and combined facilitate the continuous charging of different batteries, such as AA and AAA batteries, in the same device.

### FIELD OF THE INVENTION

The present invention relates to a battery charger, specifically to a chute-supplied battery charger of the type used for charging batteries of different sizes, such as AA and AAA batteries in widespread use. More specifically, the present invention relates to an improved battery conveying mechanism for use with such battery chargers.

### BACKGROUND

Several battery charger designs are known, including designs capable of accepting different battery geometries including widely used AAA and AA battery designs.

The present inventor has developed a chute-fed charger design, published as United Kingdom Patent Publication No GB2599157. The charger design automates the loading of a battery into a charge location, and the removal of a charged battery therefrom into a tray. This avoids the need to manually vacate the charge location and to manually feed individual empty batteries for charging, and instead enables an automated charging of a larger number of batteries. A practical extension to an automated battery feeding design is a chute-fed charger design that allows a large number of batteries to be placed into the chute, for them to be automatically charged, sequentially. Another practical extension to an automated battery feeding design is the provision of a reject mechanism that allows non-chargeable batteries to be separated from charged batteries.

In this manner, a large supply of batteries of unknown charge status may be loaded into a chute, the battery charger charging the batteries sequentially, operating in a practically continuous manner, until all batteries of the chute have been processed and sorted into charged or, as the case may be, rejected batteries. A design that provides a reliable operation, e.g., overnight, of such a charger is relatively complex, resulting in inhibitively high per-charger manufacturing costs.

The present invention seeks to provide an improved charger design.

### SUMMARY OF THE INVENTION

In accordance with a first aspect of the invention, there is provided a battery charger device as defined in claim 1, the device comprising a chute for a supply of batteries to be charged, a charge location for charging a battery, and a conveyor for conveying the batteries from the chute to the charge location, wherein the conveyor comprises a battery cradle comprising a first battery seat and a second battery seat, wherein operation of the conveyor allows a battery to be moved from the first battery seat to the second battery seat, wherein the conveyor is operable to assume a battery-receiving position to receive a battery from the chute into the first battery seat, and operable to cause movement of a battery from the first battery seat to the second battery seat for charging the battery.

Battery chargers comprising a chute, i.e., a supply chute, for feeding a supply of batteries to a charge terminal, are known, for instance from the applicant's United Kingdom patent publication GB2599157. A chute may be combined with or be integrally formed with a hopper or battery collection tray from where batteries are fed, one after another, in a sequential—and practically continuous—manner, to a charge terminal, the charge terminal processing a battery at a time. GB2599157 also discloses a battery conveying mechanism, in the form of a carousel or rotatable conveyor, that provides a better control over the movement of a battery from the chute to the charge terminal.

The conveyor provides a controlled transport of the battery from the chute to the charge location. The conveyor may comprise one or more cradles for a battery, into which a battery may be transferred (e.g., drop) from the chute. The cradle cross-section is typically in the form of a half-pipe, for instance to conform to the dimension of an AA battery or an AAA battery. In embodiments of the invention, the cradle is dimensioned to accept AA batteries and, therefore, also smaller AAA batteries.

Furthermore, a battery cradle of the invention is provided with two seating locations for a battery. The seating locations may be considered locations in which the battery may be seated (depending on orientation and/or position of the conveyor). The two seating locations may be separated by a structure inhibiting movement of a battery from one seating location to another seating location in at least some orientations of the conveyor. For instance, the seating locations may be separated by a seat-separating structure such as a ledge or step. As will be appreciated, depending on the movement, speed, change of movement direction, and/or rotation of the conveyor, a seat-separating structure may present an obstacle to a battery transfer between the first and second seating locations. Depending on conveyor movement, e.g. acceleration, deceleration, and/or change of orientation, a battery may overcome or drop over the seat-separating structure from a first seating location to a second seating location. Appropriate or coordinated conveyor movement in the opposite direction may allow the battery to return from the second seating location to the first seating location. However, in the absence of conveyor movement in the opposite direction, a battery located in the second seating location is inhibited by the seat-separating structure from returning to the other seating location. In this manner, the cradle may hold a battery in one of two (or more) seating locations, the transfer between seating locations being controllable by conveyor movement.

The charge location is understood to be a location at which a battery is brought into contact with battery charging terminals. The operation and electrical control of a battery-charging terminal to determine if a battery, when connected to it, is chargeable or not, and to charge a battery, is not as such the main focus of the invention and will not be described in detail unless required for an understanding of embodiments. The conveyor may be arranged to move a battery towards the charge location. Alternatively, in some embodiments the charge location is part of the conveyor, for instance part of a seating location, such that movement of the conveyor results in movement of the battery to the charge location while it moves from one seating location to another seating location within the battery cradle.

Movement of the conveyor may be controlled by a processor operatively connected to the charge terminal to move a new battery to the charge terminal only when the charge terminal is free to accept a new battery, i.e., empty. An appreciation underlying the invention and aspects disclosed herein was that the operation of such a conveyor, which, if motor based, requires a certain level of motor power to move batteries in an effective manner.

To provide one example, charge terminals are usually provided by sliding contacts and/or biased contact elements, such as leaf springs or otherwise spring biased arrangements to ensure a good contact of a charge terminal with the battery charge surfaces. A motor driving the conveyor will be understood to be dimensioned to allow insertion and/or removal of batteries against the inherent friction and/or against the inherent bias of such contact elements.

As another example, the inventor has observed that a supply of batteries in the chute creates a load on a battery that was just transferred into the conveyor. Particularly for a large number of batteries in a chute, a combined load of the batteries above the battery occupying a cradle may require a corresponding motor power to move the conveyor from underneath a chute. The problem may be exacerbated for larger diameter cradles dimensioned, e.g., to accept both AAA and AA batteries, when a cradle occupied by a smaller, e.g., AAA battery, and dimensioned for a larger, e.g., AA battery, has sufficient clearance for another battery to enter the cradle, which tends to interfere with conveyor movement.

By providing two seat locations, one seat location may be designed for transfer from the chute into the cradle, and another seat location may be designed for engagement with the charge location terminals. For instance, one seat location may be shallower than another seat location that is deeper than the shallower seat location, to allow a battery to effectively drop from a shallower seat location into a relatively deeper seat location. A drop may be designed such that kinetic energy of a dropping battery contributes to overcoming a friction and/or resilience of terminal contact elements. This is believed to reduce the motor power demand otherwise required when relying on motorised movement only to bring batteries into contact with the charge terminals.

In some embodiments, the depth of the first battery seat within the conveyor is less than the depth of the second battery seat.

For instance, a portion of the cradle may be shallower to provide one battery seat, and another portion of the cradle may be deeper, to provide another battery seat. The shallow portion and deep portion may be separated by a transition zone which may be a step that constitutes a seat-separating structure.

The depth of the first battery seat may be no more than 10 mm, no more than 9.5 mm, or no more than 9 mm, relative to an outer surface of the conveyor. A typical diameter of a AAA battery is in the region of 9 mm. By providing a first battery seat no deeper than, or not much deeper than, a AAA battery, it is achieved that a battery—whether AAA or larger battery—occupying the first battery seat effectively blocks transfer of another battery from a chute into the first seat of the cradle.

The depth of the second battery seat within the conveyor may be at least 1 cm, 1.5 cm, or at least 2 cm. The second battery seat may be considerably deeper than the first battery seat, to allow a battery to remain within the conveyor without protruding from it.

In some embodiments, the first battery seat is provided by a ledge providing a drop to the second battery seat, the second battery seat being shaped so as to impede return of a battery to the first battery seat.

In some embodiments, the device comprises a cradle-covering mechanism, the cradle-covering mechanism operable to cover at least a portion of the battery cradle thereby to block transfer of a battery from the chute into the battery cradle.

The cradle-covering mechanism may be provided by a cover, a lid, or the like, suitable for inhibiting and practically blocking transfer of a battery from the chute into the cradle. It will be appreciated that the cradle-covering mechanism is not necessarily a solid plate structure. For instance, the cradle-covering mechanism may be provided by a lattice structure or spaced apart elements that may still effectively block battery transfer into the cradle. Similarly, a cradle-covering mechanism may not necessarily need to cover the entire cradle, or an aperture thereof, to block battery transfer. For instance, the cradle-covering mechanism may be configured to be in one or more different positions, such as a position in which it covers the first battery seat without blocking the second battery seat, a position in which it covers the second battery seat without blocking the first battery seat, a position in which it simultaneously covers two battery seats, and/or a position in which it blocks neither the first battery seat nor the second battery seat.

In some embodiments, the cradle-covering mechanism is operable to cover the battery cradle while a battery is in the second battery seat.

By providing a cradle-covering mechanism, transfer of a battery into the cradle can be prevented while a cradle is empty. Furthermore, in cradle designs comprising a relatively deep cradle or battery seat thereof, the cradle-covering mechanism may be designed to prevent transfer of another battery on top of a cradle-occupying battery while the cradle passes the chute.

In accordance with a second aspect of the invention, there is provided a battery charger device as defined in claim 6, the device comprising a chute for a supply of batteries to be charged, a charge location for charging a battery, and a conveyor for conveying the batteries from the chute to the charge location, wherein the conveyor comprises a battery cradle, wherein the conveyor is operable to assume a battery-receiving position to receive a battery from the chute into the battery cradle, and to assume a battery-charging position for offering the battery to the charge location, wherein the device further comprises a cradle-covering mechanism, the cradle-covering mechanism operable to cover at least a portion of the battery cradle thereby to block passage of a battery from the chute into the battery cradle in the battery-receiving position.

In some embodiments, the cradle-covering mechanism is disposed on the conveyor.

The cradle-covering mechanism may be articulatably disposed on the conveyor. For instance, the cradle-covering mechanism may be slidably mounted, or pivotably mounted. In this manner, the cradle-covering mechanism may be actuatable by a control mechanism also controlling operation of the conveyor. However, in some embodiments, the cradle-covering mechanism is loosely disposed so as to move passively in response to conveyor operation. In this manner, a cradle-covering mechanism may move relative to the conveyor, e.g., due to different inertia. As may be imagined, changes is conveyor movement, speed, and/or orientation may cause the cradle cover of a cradle-covering mechanism to move between a cradle-covering position that partially or fully covers the cradle, and an open position in which it does not cover the cradle.

In some embodiments, the cradle-covering mechanism is actuatable by a battery moving in the battery cradle.

For instance, the cradle-covering mechanism may be moved by a battery (e.g., by a battery pushing against the cradle-covering mechanism depending on speed and/or orientation of the conveyor). Different cover-moving effects may be combined. For instance, the cradle-covering mechanism may be designed so as to be moveable by a battery when the conveyor has reached a threshold acceleration, deceleration, and/or orientation, and may resist being moved by a battery below the threshold acceleration, deceleration, and/or orientation.

In some embodiments, the cradle-covering mechanism is disposed on the conveyor so as to be translatable by utilising its inherent inertia to conveyor movement.

In some embodiments, the device comprises abutment structures to limit a movement range of the cradle-covering mechanism.

The abutment structures may be provided, for instance, on the conveyor to limit movement of the cradle-covering mechanism relative to the conveyor, and/or relative to the cradle to be covered by the cradle-covering mechanism.

As another example, the abutment structures may be provided, alternatively or in addition, on the battery charging device to limit movement of the cradle-covering mechanism independently of conveyor position.

In some embodiments, the cradle-covering mechanism comprises one or more upstand structures oriented to protrude away from the battery cradle, whereby passage of an upstand structure underneath the chute allows the cradle-covering mechanism to be engaged by a battery bearing against the upstand structure.

The upstand structure may be provided by a ramp structure. The upstand structure, such as a ramp, may increase interference of a battery in a chute with the cradle-covering mechanism, e.g., to inhibit movement of the cradle-covering mechanism when a battery bears against it.

In some embodiments, the conveyor is operable to assume a first battery-ejecting position to eject a battery from the battery cradle into a first location.

The battery-ejecting position may be for batteries that have been processed in the battery charge location.

In some embodiments, the conveyor is operable to assume a second battery-ejecting position that is different from the first battery-ejecting position, the second battery-ejecting position to eject a battery from the battery cradle into a second location.

The provision of two distinct battery ejecting positions allows a system to eject batteries depending on battery charge status. One of the ejecting positions may be used for rejected batteries, and another one of the ejecting positions may be used for successfully charged batteries. In this manner, the battery charge device may comprise two trays, one for rejected batteries and one for charged batteries that are ready to use.

In some embodiments, at least a first battery-ejecting position is reached by the conveyor by moving from the battery-charging position beyond the battery-receiving position.

In some embodiments, the charging location comprises an arrangement of battery-charging terminals and a multi-width cavity comprising cavity walls spaced apart by two or more different distances, the distance between cavity walls defining a clearance for a battery diameter, the distance between terminals defining a clearance for a battery length, the cavity and battery-charging terminals being shaped to accommodate at least two different battery dimensions.

The multi-width cavity may be provided by a chute structure with tapering side walls or tapered chute. The battery-charging terminals may be provided with a range of two or more inter-terminal clearances, each dimensioned to accept a different battery length. In this manner, a battery dropping into the multi-width cavity will fall or drop as far as permitted by the inter-terminal clearance. E.g., a first, higher region of the cavity may be dimensioned with wider clearance (wider wall-to-wall distance) to hold a AA battery yet will allow a AAA battery to pass (or drop through). A second, lower or deeper region of the cavity may be dimensioned with narrower clearance (narrower wall-to-wall distance) than the wider clearance, to hold a AAA battery. In this manner, the multi-width cavity may be supplied with different battery sizes, e.g., both AAA and AA batteries, wherein larger diameter (AA) batteries will be expected to drop to the first, higher and wider, clearance region, whereas smaller diameter (AA) batteries will be expected to drop to the second, lower and narrower, clearance region.

The arrangement allows a single cavity to be used for the charging of multiple battery types.

The multi-width cavity may be defined as an internal region of the conveyor. The multi-width cavity may form part of, or be constituted by, a portion of a cradle of the first or second aspects. Specifically, in cradle configurations with two battery seat locations, one of the battery seat locations may be deeper than another battery seat location. In that case, the deeper battery seat location may be configured as a multi-width cavity. The shallower battery seat location may provide a ledge from which a battery may drop into the multi-width cavity, the drop depth being determined by the clearance for a battery.

The battery terminals may be provided as part of the conveyor, and/or as a location of the battery charger, mounted separately to the conveyor. In this manner, the conveyor may be operated to move a battery in a position between a pair of battery terminals. The battery terminals may be shaped such that a single pair of terminal elements may be used to charge multiple types of batteries. As will be appreciated, the terminals may be shaped to allow charging, for instance, of AAA, AA, C, D or other types of cylindrical batteries.

In combination with a battery-drop mechanism, the kinetic energy of the battery dropping into a space between two terminals may help to form a connection against inherent friction and/or resilience of terminal elements, however such a design is not necessarily a requirement of all embodiments.

In accordance with a third aspect of the invention, there is provided a battery charger device as defined in claim 16, the device comprising a chute for a supply of batteries to be charged, a charge location for charging a battery, and a conveyor for conveying the batteries from the chute to the charge location, wherein the conveyor comprises a battery cradle, wherein the conveyor is operable to assume a battery-receiving position to receive a battery from the chute into the battery cradle, and to assume a battery-charging position for offering the battery to the charge location, wherein the charging location comprises an arrangement of battery-charging terminals and a multi-width cavity comprising cavity walls spaced apart by two or more different distances, a distance between cavity walls defining a clearance for a battery diameter, a distance between terminals defining a clearance for a battery length, the cavity and battery-charging terminals being shaped to accommodate at least two different battery dimensions.

In some embodiments, the distances of the battery-charging terminals and of the cavity walls are dimensioned to accommodate a first battery type selected from one of an AAA battery, an AA battery, a C battery, and a D battery.

In some embodiments, the distances of the battery-charging terminals and of the chute cavity walls are dimensioned to accommodate a second battery type other than the first battery type, the second type selected from one of an AAA battery, an AA battery, a C battery, and a D battery.

In some embodiments, the conveyor takes the form of a carousel.

In some embodiments, the cradle-covering mechanism is coaxially disposed relative to the carousel.

In some embodiments, at least a portion of the cradle is positioned to extend into the carousel laterally of a radial line of the carousel.

A radial line is understood to be a line extending through the centre of the carousel, and a cradle portion extending into the carousel laterally of a radial line is understood to extend offset, e.g. in parallel or at a non-parallel angle, from the radial line.

In this manner, the cradle configuration may avoid the central region of the carousel. As such, it may be designed as a deeper cradle than might otherwise be practical.

In accordance with a fourth aspect of the invention, there is provided a battery charger device as defined in claim 22, the device comprising a chute for a supply of batteries to be charged, a charge location for charging a battery, and a conveyor for conveying the batteries from the chute to the charge location, wherein the conveyor takes the form of a carousel and comprises a battery cradle, wherein the conveyor is operable to assume a battery-receiving position to receive a battery from the chute into the battery cradle, and to assume a battery-charging position for offering the battery to the charge location, wherein at least a portion of the cradle is positioned to extend into the carousel laterally of a radial line of the carousel.

In some embodiments, the cradle comprises a first battery seat and a second battery seat, wherein one of the seats is positioned to extend into the carousel along a radial line of the carousel and another one of the seats is provided by the portion positioned to extend laterally of the radial line of the carousel.

The first and second battery seats may be designed such that one seat is located along a radial line of the carousel. A battery dropping from the chute into a seat along a radial line of the carousel was found to be less likely to exert rotational force onto the carousel, when its force vector is better aligned with the radial line. By providing another battery seat of the cradle laterally offset from the radial line of the carousel, the second battery seat may be designed deeper, while the force exerted of a battery dropping from the chute into the first battery seat is relatively smaller.

In some embodiments, the conveyor takes the form of belt structure.

The conveyor may be provided in the form of a segmented conveyor belt or in the form of a continuous conveyor belt.

In some embodiments, the conveyor takes the form of a shuttle.

The shuttle may be moveable, e.g., translatable and/or rotatable, e.g. by movement along a track.

Any one or more embodiments of the first aspect, second aspect, third aspect and/or the fourth aspect may be used in combination with any one or more embodiments of the respective other aspects, and combinations of such aspects.

### DESCRIPTION OF THE FIGURES

Exemplary embodiments of the invention will now be described with reference to the Figures, in which:

FIG. 1 is an isometric view of a charger device;

FIG. 2 is an isometric view of parts of the FIG. 1 device;

FIG. 3 is a side view of a component of the FIG. 1 device;

FIG. 4 is a side view of another component of the FIG. 1 device;

FIG. 5 is an isometric view showing parts of the FIG. 1 device;

FIGS. 6 and 7 are isometric views of a battery charging location; and

FIGS. 8 to 19 are side views each showing different conditions of the FIG. 1 device.

### DESCRIPTION

Referring to the Figures, a battery charging device 10 comprises a chute 12 to be fed from a hopper 11 and providing a supply path from the hopper 11 to a carousel 20. The carousel 20 constitutes a conveyor and comprises a cradle 22 for accepting a battery from the chute 12. The carousel 20 is mounted, here on an axle 15, allowing it to be rotated so as to move the cradle 22 between different positions. In this manner, the carousel 20 is disposed to move a battery from a position underneath the chute 12, constituting a battery-receiving position, to one or more other positions. The other positions may be a charge location at which a battery may be charged, a first eject position 13 and a second eject position 14, wherein one of the eject positions may be used for ejection of charged batteries, and the other of the eject positions may be used for ejection of rejected batteries. It will be appreciated that the transfer of batteries along the chute 12 is achieved through gravity, and as such the battery charger device 10 is of a gravity-fed design.

As will be appreciated, rotation of the carousel 20 may be effected by motorised control of the axle 15 under the instructions of a processor or other suitable control unit.

The hopper 11 and chute 12 are embodied by a return path comprising a hopper ramp 11a leading into a chute entrance 12a, a chute ramp 12b and a chute end 12c. The hopper ramp 11a comprises a return lip forming a guide section 11b spaced above and generally parallel to the chute ramp 12b. The guide section 11b extends to form a free end 11c. The chute end 12c defines the end of a floor of the chute 12 and the free end 11c defines the end of a ceiling of the chute 12.

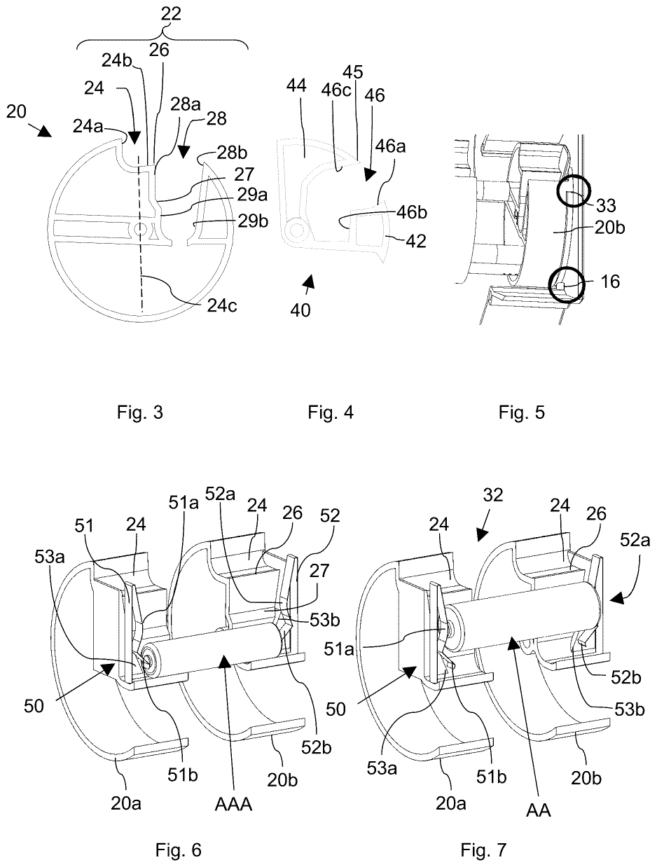

FIG. 3 is a side view of the carousel 20. The carousel 20 comprises a cradle 22 that is formed with several seating locations for a battery to be provided. To this end, the cradle 22 has a multi-tier recess, comprising a first pocket 24 that provides a first battery seat adjoining a second pocket 28 that constitutes a second battery seat. The first pocket 24 comprises a first side wall 24a and a plateau region 24b providing part of the first battery seat, the plateau region 24b ending in a step 26 providing a stepped transition (providing a drop) to the second pocket 28. The first pocket 24 is positioned generally on a radial line 24c extending through the centre of the carousel 20. In this manner, the weight of a battery dropping into the first pocket 24 creates only a small, and potentially negligible, force to rotate the carousel 20, which is believed to reduce the motorisation requirements of a motor driving and holding in position the conveyor. The second pocket 28 is offset from the radial line 24c, and thereby extends into the carousel laterally of the radial line 24c. Being offset from the radial line 24c, the pocket 28 may be designed to extend deeper into the body of the carousel 20 while staying clear of the centre and axle 15 when mounted in the device 10.

The step 26 provides a separation structure within the cradle 22 between the adjacent battery seats constituted by the pockets 24, 28. The second pocket 28 comprises a tapered chute, constituting a cavity providing a charge location, in the form of first pair of side walls 28a, 28b having a first inter-sidewall clearance (width) in a higher region of the second pocket 28 and a second pair of side walls 29a, 29b having second inter-sidewall clearance (width) in a deeper region of the second pocket 28, the second pair of side walls 29a, 29b being spaced apart less than the first pair of side walls 28a, 28b. A ramped threshold 27 is provided underneath the step 26 in a transition zone between a first side wall 28a and a second side wall 29a. In this example, the inter-sidewall clearance between the first pair of side walls 28a, 28b corresponds to a diameter of AA battery, and the inter-sidewall clearance between the second pair of side walls 29a, 29b corresponds to a diameter of a AAA battery. This provides a multi-width cavity constituted by the second pocket 28.

The side walls 28a, 28b and 29a, 29b of a pair are not parallel to each other, and instead at a slight angle of incline, to allow slight variations in battery diameter to be accommodated. To this end, the inventor has observed that diameters designated as “standard” AAA or AA batteries may deviate in the region of a millimetre, or sometimes more, from an expected standard size. For instance, the specifications for a standard AA battery allow it to have a diameter between 9.5 mm and 10.5 mm. The variations in battery dimension may not be noticeable in practical day-to-day use. However, by providing a tapering side wall geometry, a better battery seat can be achieved regardless of diameter variations. In the example shown herein, one continuous surface provides portions 28b and 29b of the first and second side wall pairs, however this is not necessarily the case in all embodiments.

The tapered cavity provided by the second pocket 28 is open to the side of the carousel 20 (in a direction parallel to its axis of rotation). In this manner, the lateral openings of the second pocket 28 are free sides so as to permit contact between a battery in the second pocket 28 and laterally positioned contact terminals.

With reference to FIGS. 6 and 7, a charge location 50 comprises two arms 51, 52 providing electrical contact points for charging a battery that are located on opposite free sides of the carousel 20. Herein, the two arms 51, 52 are integrated with the cradle 22 along the second pocket 28, and therefore rotate with the carousel 20. In an alternative configuration, the two arms may be fixed relative to a housing (not shown) of the battery charger device 10 such that the carousel 20 rotates relative to the arms. Likewise, charge contact terminals may be provided with in the housing (not shown) for electrical connection to the two arms 51, 52. Regardless of the implementation of the arrangement, it will be appreciated that FIGS. 6 and 7 show a configuration in which the two arms 51, 52 are aligned within the cradle 22, or respectively-in which the cradle 22 has been aligned with the two arms 51, 52. As such, FIGS. 6 and 7 show the carousel 20 in a battery-charging position. Movement of the carousel 20 allows a battery to be transported from the chute 12 to the charge location which in the illustrated embodiment is achieved when a battery is in the second battery seat and aligned between the two arms 51, 52. The terminals may be located to occupy a position centrally between the sidewalls 28a, 28b and 29a, 29b, such that a cylindrical battery dropping into position is thereby radially aligned with the terminals. The opposite ends of the second pocket 28 are provided with a first ridge structure 53a and a second ridge structure 53b that provide a tapering axial clearance profile, and thereby provide different lengths of free end-to-end space of the second pocket 28. Due to the tapering profile, the axial clearance is narrower (shorter) in the region of the second pair of side walls 29a, 29b, whereas the axial clearance is wider (longer) in the region of the first pair of side walls 28a, 28b. the first and second ridge structures 53a, 53b help to axially centre a smaller (here: AAA) battery between the two arms 51, 52. This, in turn, helps to ensure that appropriate electrical contact is made between the two arms 51, 52 and a battery dropping into the second pocket 28 of the cavity.

In the battery-charging position, a battery will have transferred from the first battery seat (provided by the first pocket 24) over the step 26 into the second battery seat (provided by the second pocket 28). FIG. 6 shows a configuration in which the battery is a AAA type battery. FIG. 7 shows a configuration in which the battery is a AA type battery that is larger than the AAA battery, the battery charge location 50 being otherwise the same as in FIG. 6. The first arm 51 comprises a first-arm shoulder 51a and a first-arm free end 51b. Opposite the first arm 51, the second arm 52 comprises a second-arm shoulder 52a and a second-arm free end 52b. Both arms 51, 52 are resiliently biased, here by virtue of being of a leaf spring design, although other biasing means may be used, such as a helical spring positioned beneath a contact element. The arms are shaped in a generally tapering manner providing a progressively narrower axial clearance with increasing depth of the second pocket 28. The free ends 51b, 52b are each positioned underneath a return end of the arms 51, 52, their distal ends being rolled to avoid a sharp contact surface.

The shoulders 51a, 52a are spaced apart from each other by a distance a little shorter than a standard AA battery and located at a level where the wall-to-wall distance of the first pair of side walls 28a, 28b corresponds to a diameter of a AA battery. In this manner, a AA battery dropping into the second pocket 28 is stopped by abutment of the AA battery mantle against the side walls 28a, 28b, the battery's distal ends coming into contact with the shoulders 51a, 52a for charging, in a configuration indicated in FIG. 7. In this region, the tapering side walls 28a and 28b prevent further dropping of a AA battery. It will be understood that a slightly smaller diameter variant of an AA battery will be located a little deeper, and a slightly larger diameter variant of an AA battery will be located a little higher. In this manner, the tapering side walls are able to accommodate slight variations in battery design and/or batteries that may have been labelled with tape by a user.

Similarly, the free ends 51b, 52b are spaced apart from each other by a distance a little shorter than a standard AAA battery and located at a level where the wall-to-wall distance of the second pair of side walls 29a, 29b corresponds to a diameter of a AAA battery. A AAA battery dropping into the second pocket 28 is able to pass the shoulders 51a, 52a. The drop of a AAA battery may occur in two phases, first from the step 26 to the ramped threshold 27, and then further down. While a relatively deeper drop increases the contact-making force with the free ends 51b, 52b, the provision of a ramped threshold 27 separates the drop into phases and thereby reduces the risk that an AAA battery might otherwise rotate to land end-forward in the cavity. The distal ends of the AAA battery may engage with the first and second ridges 53a, 53b to assist with the axial centring of the AAA battery until it is stopped by abutment of the AAA battery mantle against the side walls 29a, 29b, the distal ends coming into contact with the free ends 51b, 52b for charging, in a configuration indicated in FIG. 6. The tapering side walls 29a and 29b are able to accommodate variations in AAA diameter, as set out above.

Rotation of the carousel 20 allows the cradle 22 to be oriented into several positions or orientations. In a battery-receiving position, the cradle 22 is oriented to face the chute 12 for transfer of a battery 1 into the cradle 22. In a battery-charging position, the cradle 22 is oriented to allow batteries to drop into the second pocket 28. Likewise, the carousel 20 may be rotated to one of the eject positions 13 or 14 described above. Retention of a battery in the cradle 22 can be controlled by a cradle-covering mechanism in the form of an armature 40 described in the following paragraphs.

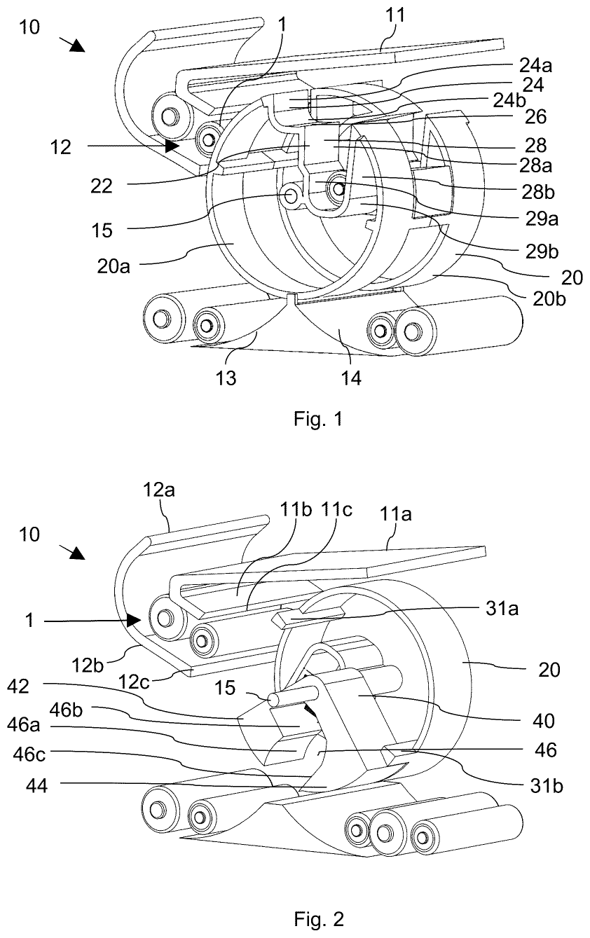

The carousel 20 is, in this embodiment, of a two-component form comprising a first carousel part 20a and a second carousel part 20b. The two carousel parts 20a, 20b comprise the same pocket design to provide, when joined, the cradle with battery seats. In a clearance recess 32 (see FIG. 7) defined by a free space between the carousel parts 20a, 20b, there is pivotably disposed an armature 40. Referring now to FIG. 2, in which the first carousel part is omitted for a clearer illustration of the armature 40, the armature 40 is disposed on the axle 15, i.e., coaxially with the carousel 20, although a coaxial or pivotal mounting is not necessarily a requirement of all embodiments.

FIG. 4 is a side view of the armature 40. The armature 40 has a first jaw 42 and a second jaw 44 defining between them a recess 46. The recess 46 comprises an elbow formed by a first side wall 46a with a transition into a side arm 46b opposite a generally straight second side wall 46c. The armature 40 is pivotable relative to the carousel 20 and pivotable independently of the carousel 20.

Referring to FIG. 2, the carousel 20 comprises, here indicated as part of the second carousel part 20b, two protrusions providing a first end stop 31a and a second end stop 31b to limit the rotational range of the armature 40 relative to the carousel 20. The recess 46 of the armature 40 is laterally open so as to allow a battery to be seated in the recess 46, and to laterally protrude beyond the recess 46, the laterally protruding battery portions engaging in the seating locations of the cradle 22. The outer surfaces of the first and second jaws 42, 44 are curved generally corresponding to the outer radius of the carousel 20, wherein one of the jaws 44 comprises a region of increasing radius providing a ramp region 45 constituting an upstand structure. The armature 40 is disposable (here: pivotable) relative to the cradle 22 such that pivoting of the armature 40 between the first and second end stops 31a, 31b may result in a selective covering of the cradle 22 either by a portion of the first jaw 42 or by a portion of the second jaw 44. In this manner, the first and second jaws 42, 44 of the armature 40 provide a cradle-covering mechanism. In this example, the sector region covered by the first jaw 42 corresponds to the opening size of the second pocket 28, and the sector region covered by the second jaw 44 corresponds to the opening size of the entire cradle 22, i.e., both the first pocket 24 and the second pocket 28. In this manner, and as will be illustrated below, appropriate positioning of the first jaw 42 provides a configuration that allows one battery seat to be covered without blocking another battery seat, and the appropriate positioning of the second jaw 44 provides a configuration that allows both battery seats to be blocked by the same cradle covering mechanism.

FIG. 5 shows a partial view of a portion of the second carousel part 20b comprising a carousel end stop 33 that may be brought into abutment with a corresponding charger housing abutment 16, to limit rotation of the carousel 20 relative to the housing. A corresponding configuration of carousel end stop and housing abutment structure may be provided on the side of the first carousel part 20a (not shown in FIG. 5).

In the following description, for ease of reference, the expressions counterclockwise (CCW) and clockwise (CW) may be used with reference to the side elevation presented in the Figures, although it will be understood that the invention is not limited to an operation of the device 10 in a particular direction.

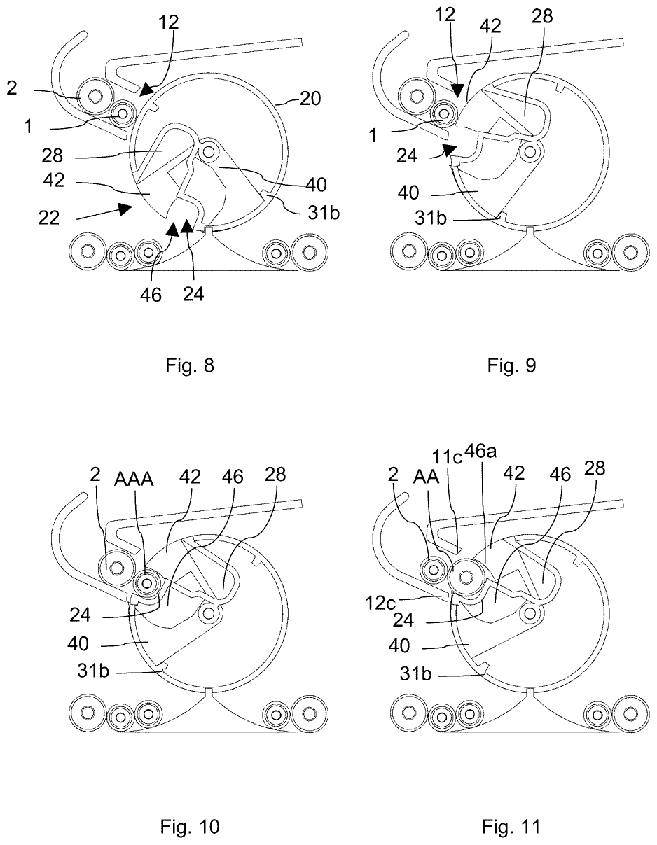

FIG. 8 shows an eject position, which may also be a start position, in which the carousel 20 is rotated in the counterclockwise position to an end point at which the cradle 22 is open towards the first eject position 13, and the armature 40 depends, by virtue of gravity, between the two carousel parts 20a, 20b. In armature 40 is oriented such that the first jaw 42 blocks the second pocket 28 without blocking the first pocket 24.

In FIG. 9, the carousel 20 has been rotated, clockwise, closer towards a battery-receiving position, and has not yet reached a battery-receiving position (to be shown in FIGS. 10 and 11). Rotation of the carousel 20 causes the second end stop 31b to pull along the armature 40 that remains rotationally aligned with the carousel 20 such that the first jaw 42 blocks the second pocket 28 of the cradle 22. In this manner, a transfer of a battery 1 is prevented while the cradle 22 passes underneath the chute 12.

In FIG. 10, the carousel 20 has been rotated further clockwise, such that the recess 46 of the armature 40, here aligned with the first pocket 24, allows transfer of a AAA battery into the first pocket 24. In this configuration, the first side wall 46a of the second jaw 44 blocks transfer of the AAA battery from the first pocket 24 to the second pocket 28. The depth of the first pocket 24 is in the region of 9 mm. As such, a portion of a AAA battery occupying the first pocket 24 protrudes outside the carousel 20 and blocks transfer of a subsequent battery 2.

FIG. 11 shows a configuration similar to FIG. 10, wherein a AA battery is transferred into the first pocket 24. Due to its larger diameter, the AA battery abuts against the first side wall 46a of the first jaw 42, which pushes the armature 40 clockwise. The mass and relative inertia of the armature 40 prevents further pushing than required by the AA battery to occupy the first pocket 24, and therefore also prevents a transfer of the AA battery into the second pocket 28 while the carousel is in the battery-receiving position. The AA battery has a larger diameter than the 9 mm pocket depth designed for a AAA battery, and protrudes by a corresponding amount from the cradle 22. This blocks transfer of a subsequent battery 2 into the cradle 22. It will be appreciated that the free end 11c of the guide section 11b extends less closely to the carousel 20 than the chute end 12c, thereby providing clearance for a AA battery in the first pocket 24 during clockwise transfer.

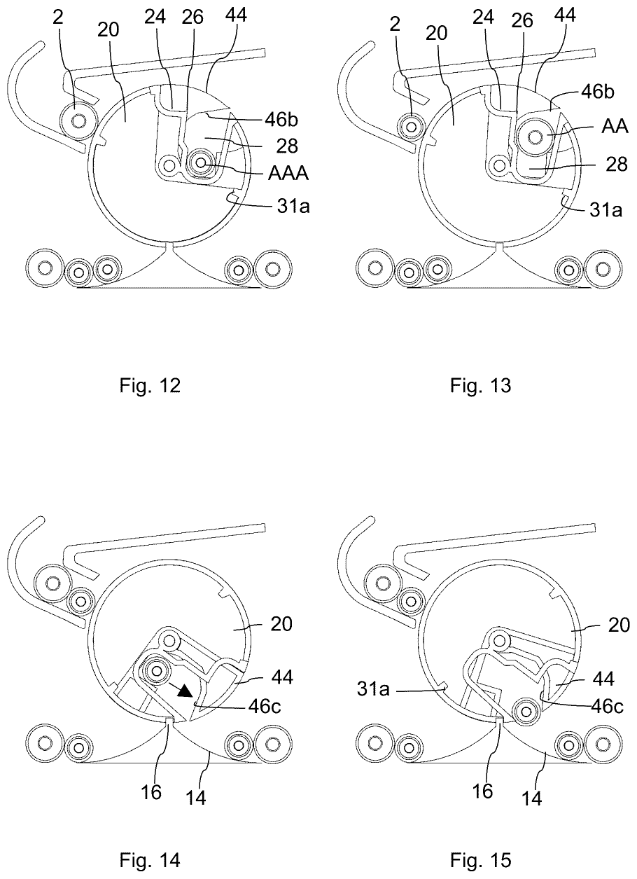

FIGS. 12 and 13 show the carousel 20 rotated further clockwise into a battery-charging position. FIG. 12 is a condition following the transfer of a AAA battery shown in FIG. 10 and corresponds to FIG. 6. FIG. 13 is a condition following the transfer of a AA battery shown in FIG. 11 and corresponds to FIG. 7. In both FIGS. 12 and 13, the clockwise rotation of the carousel 20 has resulted in a shift of the centre of gravity of the armature 40, which has pivoted to abut against the first end stop 31a. The pivoting of the armature 40 removes the first side wall 46a from the second pocket 28 and, likewise, causes the second side wall 46c to push the battery from the first pocket 24 over the step 26 into the second pocket 28. The components are designed such that the armature 40 is effectively moved by gravity, corresponding to an orientation of the first and second end stops 31a, 31b located on the carousel 20. However, in variations of the design a conveyor, such as a shuttle or the carousel, may be motor-controlled to accelerate or decelerate (e.g., stop suddenly) in a manner utilising inertia of the armature 40 or a variant thereof to cause it to move relative to the conveyor. As an alternative to movement of the armature 40 in dependence on conveyor operation, movement of the armature 40 may be controlled by a separate motor.

The configuration of the tapered cavity and the charge location 50 (see FIGS. 3, 6 and 7, and corresponding description) allows a battery to drop into a suitable charging position for either a AAA or AA battery within the same cradle 22, without the battery charging device 10 having to be configured with multiple individual cradles for a specific battery type.

In the charging location, an electrical connection is made between the terminal arms 51, 52 (FIGS. 6 and 7) and the contacts of the battery to be charged. The battery charging device 10 may be configured with monitoring and testing circuitry that allows it to test the suitability of a battery for charging. A decision logic may make a determination whether or not the battery can be charged. If a battery cannot be charged, it may be treated as a reject battery. If a battery can be charged, the decision logic may proceed to charge the battery. If a battery is fully charged or does not need to be charged further, the decision logic may treat the battery as charged and ready for ejection. While the battery is to be charged, the decision logic may control the carousel to remain in the battery-charging position.

A reject battery may be transferred to the reject position (here, a second eject position 14), described in FIGS. 14 to 16.

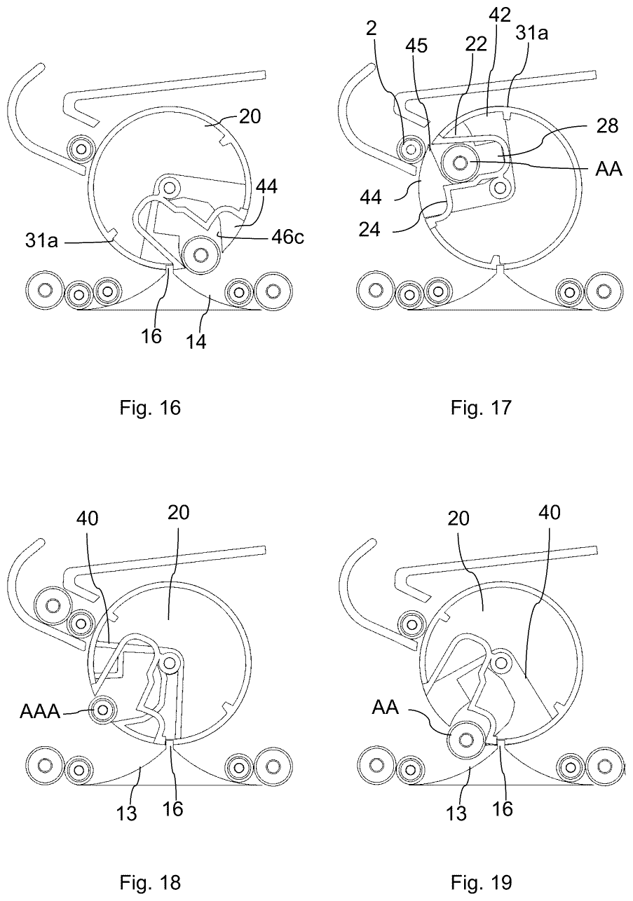

In FIG. 14, the carousel 20 has been rotated clockwise. The carousel end stop 33 and a charger housing abutment 16 that, when in abutment, limit the clockwise rotation of the carousel 20. The battery is still held in the second pocket 28 and may to some degree be wedged between the arms 51, 52 (see FIGS. 6 and 7), such that it may resist a dropping out of the second pocket 28 even if the pocket 28 is in an upended position. The clockwise rotation also causes the armature 40 to follow the rotation of the carousel 20 while it rests against the first end stop 31a. However, it will be appreciated that further clockwise rotation of the carousel 20 will reach a point beyond which the first end stop 31a no longer holds the armature 40 which may, effectively, hang freely, i.e., under the influence of gravity, between the first and second end stops 31a, 31b. In this position, the first side wall 41a comes into abutment with the battery and thereby helps to push it out of the second pocket 28, if it has not dropped by virtue of its own mass. The battery ejection is illustrated in FIG. 15 for a AAA battery and in FIG. 16 for a AA battery. The larger clearance required for ejection of a AA battery is achieved by allowing the battery to push against the second side wall 46c, which moves the armature 40 counter-clockwise. The configuration allows the same mechanism and eject position to be used for ejection of a battery whether this is a AAA type or a AA type.

If, in the battery-charging position illustrated in FIG. 12 or 13, the decision logic has determined that the battery is charged and ready for ejection, the carousel is operated in a counterclockwise direction illustrated in FIGS. 17 to 19.

Moving counterclockwise from the battery-charging position to the first eject position 12, the cradle 22 passes the chute 12. To this end, the armature 40 is still in a counterclockwise position indicated in FIGS. 12 and 13, respectively. In this position relative to the cradle 22, the second jaw 44 covers the cradle 22, both the first pocket 24 and the second pocket 28. As illustrated in FIG. 17, due to the depth of the second pocket 28, the cradle 22 can be fully covered by the second jaw 44 when the second pocket 28 is occupied by a AA battery. While the cradle 22 passes under the chute 12 as the carousel 20 rotates, the ramp structure 45 is engaged by a battery 2, which thereby inhibits and practically prevents free rotation of the armature 40 under the influence of gravity. In this manner, the armature 40 continues to block the cradle 22 while passing the chute 12. It is anticipated that, in the absence of a battery 2 (i.e., when the chute 12 is empty), no external battery bears against the ramp structure 45, whereby the armature 40 is not inhibited from rotating freely to open the cradle 22. This would not be considered a problem, becausein that case there is no concern of a battery prematurely dropping into the cradle.

As will be appreciated, the armature 40 is initially pulled along in a counterclockwise direction by the first end stop 31a, until a point is reached at which the armature 40 may drop, by virtue of gravity, thereby unblocking the cradle 22. The weight distribution, position and angle of the chute 12, and centre of gravity of the armature 40 are selected such that the armature 40 drops not before a battery 2 has passed the ramp structure 45, and therefore not before the cradle 22 has passed the chute 12. In this manner, the armature 40 acts as a cradle-covering mechanism. The outer circumference of the body of the carousel 20 continues to hold batteries in the chute 12. A battery is free to drop from the cradle 22 into the first eject position 13. The battery may drop after a dislodging push from the first side wall 46a against the battery. The battery ejection is illustrated in FIG. 18 for a AAA battery and in FIG. 19 for a AA battery. The configuration allows the same mechanism and eject position to be used for ejection of a battery whether this is a AAA type or a AA type.

After removal of the battery from the cradle 22, the device 10 is in the start position shown in FIG. 8, in which the device 10 is ready to rotate the carousel 20 to the battery-receiving position to receive another battery 2 from the chute 12.

Whilst the description refers to AA and AAA type batteries, it will be appreciated that the principle of the invention may be employed for other battery types, and may also be used for a single-type battery charger or for a design capable to accept more than two battery geometries by appropriate design of the second pocket.

The armature is illustrated as a coaxially mounted component. However, the armature does not necessarily need to be coaxially mounted with the carousel. For instance, instead, the armature may be mounted on a different axis of the carousel. Furthermore, the armature may be mounted in a manner other than pivotable, e.g., it may be slidably disposed on the carousel or other type of conveyor.

The exemplary embodiment described herein uses a conveyor in the form of a rotationally disposed carousel. However, it will be appreciated that the conveyor may be constituted by a translatable carrier, such as a shuttle, or by a belt mechanism, such as a conveyor belt, providing translational movement of a battery from a chute to a charging station and to one or more eject positions.

In embodiments, the chute 12 has been designed such that it is aligned and oriented towards the axle 15 of the battery charging device. This reduces and practically avoids an angular force that might otherwise interfere with motor movement. The first pocket 24 is positioned generally along a radial line extending through the centre of the carousel 20, so as to lie along a line between the chute end 12c and the axle 15 in the battery-receiving position. Thereby, the drop of a battery into the first pocket 24 creates little, or negligible, momentum on the carousel 20. In contrast, the second pocket 28 is positioned laterally of the centre of the carousel 20, i.e., laterally of the axle 15, such that a deeper pocket can be more easily accommodated.

The device 10 is described with two eject positions 13 and 14. Either one of the eject positions may be used as the reject position and for charged batteries. It is believed that the majority of batteries used with the device will usually be successfully chargeable. For this reason, the battery charger may be designed such that the shorter travel path, here from the charging location to the eject position 14, is used for charged batteries, and the relatively longer travel path, here from the charging location to the eject position 13, is used for reject batteries.

While the different aspects disclosed herein may be incorporated into a charging device without also incorporating other aspects, several or all aspects described herein may be combined in a multi-battery charger device. A pocket extending laterally offset from a radial line of a carousel allows a relatively deeper cradle pocket to be provided. The cradle-covering mechanism further improves the practicality of a relatively deeper cradle geometry, by allowing transfer of a battery from the chute to be selectively blocked, such that a cradle is used by a single battery at a time. The seating locations within the cradle allow a battery to first drop a small amount, and along the radial extension of the carousel axle, reducing the motor power requirements. Furthermore, the combination of different seating locations and a deeper cradle pocket allows a battery to drop within the conveyor to engage with the charging terminals. The multi-width charging cavity, here embodied by a deeper pocket portion with tapering and stepped sidewalls providing different wall-to-wall spacing, was found to facilitate the design of a single charging position within a conveyor that can be used not only by different battery types, but was in addition found to be suitable for variations of battery dimensions observed on a single battery type, such as a AA-type battery marked with insulating tape and a AA-type battery without such marker tape.

Whilst the principle of the invention has been illustrated using exemplary embodiments, it will be understood that the invention is not so limited, and that the invention may be embodied by other variants defined within the scope of the appended claims.

1. A battery charger device comprising a chute for a supply of batteries to be charged, a charge location for charging a battery, and a conveyor for conveying the batteries from the chute to the charge location, wherein the conveyor comprises a battery cradle comprising a first battery seat and a second battery seat, wherein operation of the conveyor allows a battery to be moved from the first battery seat to the second battery seat, wherein the conveyor is operable to assume a battery-receiving position to receive a battery from the chute into the first battery seat, and operable to cause movement of a battery from the first battery seat to the second battery seat for charging the battery.

2. The device according to claim 1, wherein a depth of the first battery seat within the conveyor is less than a depth of the second battery seat.

3. The device according to claim 1, wherein the first battery seat is provided by a ledge providing a drop to the second battery seat, the second battery seat being shaped so as to impede return of a battery to the first battery seat.

4. The device according to claim 1, comprising a cradle-covering mechanism, the cradle-covering mechanism operable to cover at least a portion of the battery cradle thereby to block transfer of a battery from the chute into the battery cradle.

5. The device according to claim 4, wherein the cradle-covering mechanism is operable to cover the battery cradle while a battery is in the second battery seat.

6. A battery charger device comprising a chute for a supply of batteries to be charged, a charge location for charging a battery, and a conveyor for conveying the batteries from the chute to the charge location, wherein the conveyor comprises a battery cradle, wherein the conveyor is operable to assume a battery-receiving position to receive a battery from the chute into the battery cradle, and to assume a battery-charging position for offering the battery to the charge location, wherein the device further comprises a cradle-covering mechanism, the cradle-covering mechanism operable to cover at least a portion of the battery cradle thereby to block passage of a battery from the chute into the battery cradle in the battery-receiving position.

7. The device according to claim 6, wherein the cradle-covering mechanism is disposed on the conveyor.

8. The device according to claim 6, wherein the cradle-covering mechanism is actuatable by a battery moving in the battery cradle.

9. The device according to claim 6, wherein the cradle-covering mechanism is disposed on the conveyor so as to be translatable by utilising its inherent inertia to conveyor movement.

10. The device according to claim 6, comprising abutment structures to limit a movement range of the cradle-covering mechanism.

11. The device according to claim 6, wherein the cradle-covering mechanism comprises one or more upstand structures oriented to protrude away from the battery cradle, whereby passage of an upstand structure underneath the chute allows the cradle-covering mechanism to be engaged by a battery bearing against the upstand structure.

12. The device according to claim 6, wherein the conveyor is operable to assume a first battery-ejecting position to eject a battery from the battery cradle into a first location and wherein the conveyor is operable to assume a second battery-ejecting position that is different from the first battery-ejecting position, the second battery-ejecting position to eject a battery from the battery cradle into a second location.

13. (canceled)

14. The device according to claim 12, wherein at least a first battery-ejecting position is reached by the conveyor by moving from the battery-charging position beyond the battery-receiving position.

15. The device according to claim 1, wherein the charge location comprises an arrangement of battery-charging terminals and a multi-width cavity comprising cavity walls spaced apart by two or more different distances, the distance between cavity walls defining a clearance for a battery diameter, the distance between terminals defining a clearance for a battery length, the cavity and battery-charging terminals being shaped to accommodate at least two different battery dimensions.

16. (canceled)

17. (canceled)

18. (canceled)

19. The device according to claim 6, wherein the conveyor takes the form of a carousel, wherein the cradle-covering mechanism is coaxially disposed, relative to the carousel.

20. (canceled)

21. The device according to claim 19, wherein at least a portion of the cradle is positioned to extend into the carousel laterally of a radial line of the carousel.

22. A battery charger device comprising a chute for a supply of batteries to be charged, a charge location for charging a battery, and a conveyor for conveying the batteries from the chute to the charge location, wherein the conveyor takes the form of a carousel and comprises a battery cradle, wherein the conveyor is operable to assume a battery-receiving position to receive a battery from the chute into the battery cradle, and to assume a battery-charging position for offering the battery to the charge location, wherein at least a portion of the cradle is positioned to extend into the carousel laterally of a radial line of the carousel.

23. The device according to claim 22, wherein the cradle comprises a first battery seat and a second battery seat, wherein one of the seats is positioned to extend into the carousel along a radial line of the carousel and another one of the seats is provided by the portion positioned to extend into the carousel laterally of the radial line of the carousel.

24. (canceled)

25. (canceled)

26. The device according to claim 1, wherein the conveyor takes the form of a carousel, the device further comprising a cradle-covering mechanism operable to cover at least a portion of the battery cradle thereby to block transfer of a battery from the chute into the battery cradle, wherein the cradle-covering mechanism is coaxially disposed, relative to the carousel.

27. The device according to claim 26, wherein at least a portion of the cradle is positioned to extend into the carousel laterally of a radial line of the carousel.
